(19) United States
(12) Patent Application Publication
(10) Pub. No.: US 2024/0203111 A1
(43) Pub. Date: Jun. 20, 2024

(54) MACHINE LEARNING-BASED VIDEO ANALYTICS USING CAMERAS WITH DIFFERENT FRAME RATES

(71) Applicant: Cisco Technology, Inc., San Jose, CA (US)

(72) Inventor: Bogdan Ionut Tudosoiu, Lund (SE)

(21) Appl. No.: 18/081,049

(22) Filed: Dec. 14, 2022

(51) Int. Cl. G06V 10/82; G06T 3/40; G06T 3/60; G06T 5/00; G06V 20/40; G06V 40/20; H04N 5/265

(52) U.S. Cl. CPC G06V 10/82; G06T 3/40; G06T 3/608; G06T 5/002; G06V 20/44; G06V 40/20; H04N 5/265; G06T 2207/20036

(57) ABSTRACT

In one embodiment, a device makes an inference about video data from a first camera using a machine learning model. The device processes video data from a second camera that has a lower frame rate than that of the video data from the first camera. The device performs a mapping of the inference about the video data from the first camera to the video data from the second camera processed by the device. The device provides an indication of the mapping for display.

### TECHNICAL FIELD

The present disclosure relates generally to computer networks, and, more particularly, to machine learning-based video analytics using cameras with different frame rates.

### BACKGROUND

Video analytics techniques are becoming increasingly ubiquitous as a complement to new and existing surveillance systems. For instance, person detection and reidentification now allows for a specific person to be tracked across different video feeds throughout a location. More advanced video analytics techniques also attempt to detect certain types of events, such as a person leaving a suspicious package in an airport.

Machine learning represents a promising technology within the field of video analytics. However, the requirements of a given machine learning model and the hardware capabilities of the camera system are often unaligned. For example, prioritizing camera performance in terms of higher video resolution, High Dynamic Range (HDR) support, and the like, can still lead to bottlenecks with respect to the inference rate of the machine learning model that analyzes the video captured by the camera.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example system for performing video analytics;

FIG. 4 illustrates an example architecture for machine learning-based video analytics using cameras with different frame rates;

FIG. 5 illustrates an example of the use of the architecture of FIG. 4 for video analytics; and

FIG. 6 illustrates an example simplified procedure for machine learning-based video analytics using cameras with different frame rates.

### DESCRIPTION OF EXAMPLE EMBODIMENTS

### Overview

According to one or more embodiments of the disclosure, a device makes an inference about video data from a first camera using a machine learning model. The device processes video data from a second camera that has a lower frame rate than that of the video data from the first camera. The device performs a mapping of the inference about the video data from the first camera to the video data from the second camera processed by the device. The device provides an indication of the mapping for display.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words. LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

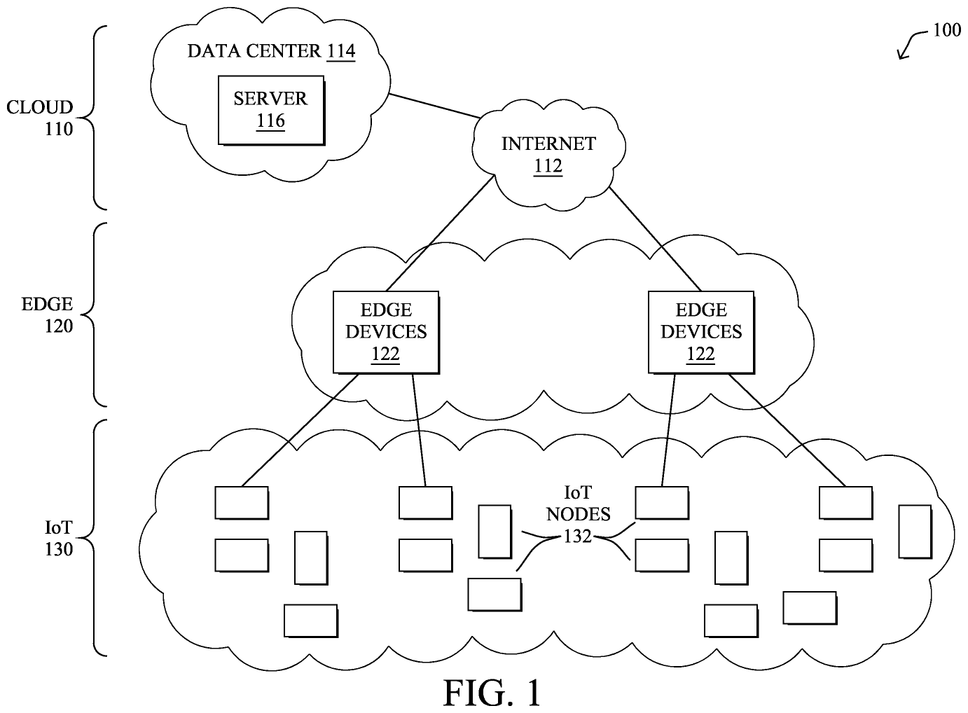

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), or other shared-media protocols where appropriate. In this context, a protocol consists of a set of rules defining how the nodes interact with each other.

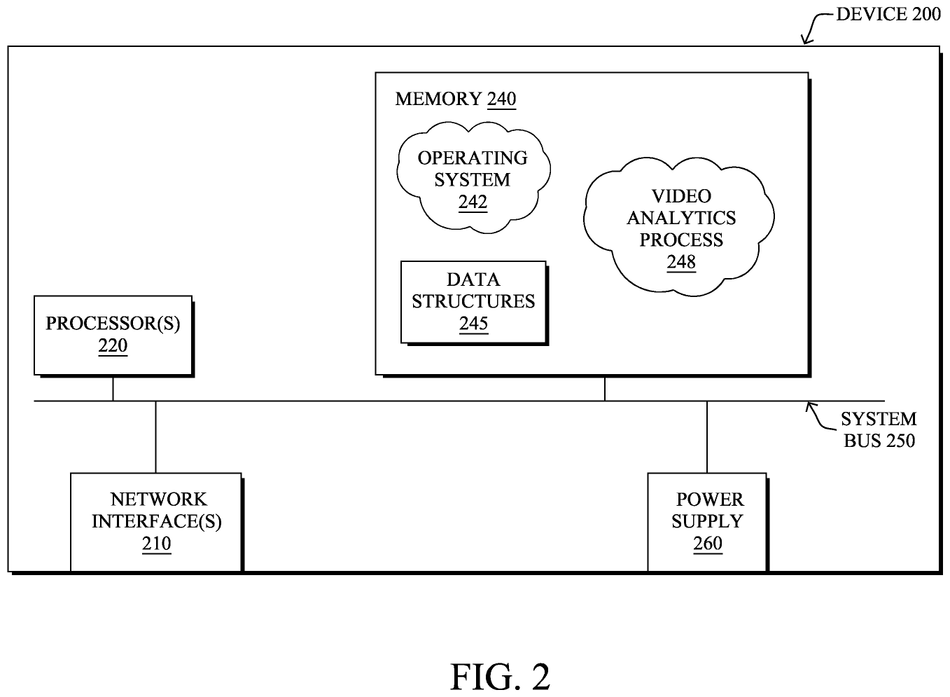

FIG. 2 is a schematic block diagram of an example node/device 200 (e.g., an apparatus) that may be used with one or more embodiments described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative video analytics process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various embodiments, video analytics process 248 may employ one or more supervised, unsupervised, or self-supervised machine learning models. Generally, supervised learning entails the use of a training set of data that is used to train the model to apply labels to the input data. For example, the training data may include sample video data depicting a particular event that has been labeled as such. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Self-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

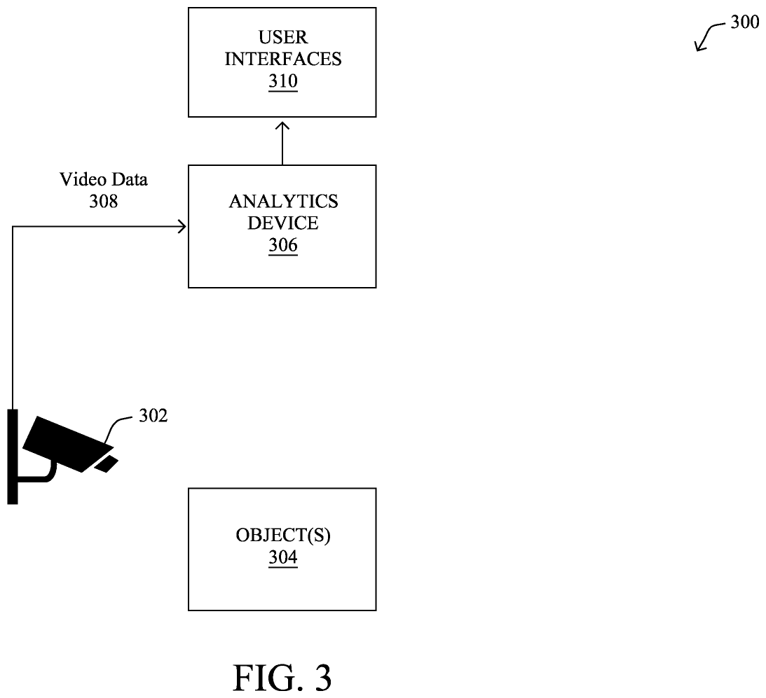

FIG. 3 illustrates an example system 300 for performing video analytics, as described in greater detail above. As shown, there may be any number of cameras 302 deployed to a physical area. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, camera 302 may generate and send video data 308, respectively, to an analytics device 306 (e.g., a device 200 executing video analytics process 248 in FIG. 2). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, camera 302 itself, or the like.

In general, analytics device 306 may be configured to provide video data 308 for display to one or more user interfaces 310, as well as to analyze the video data for events that may be of interest to a potential user. To this end, analytics device 306 may perform object detection on video data 308, to detect and track any number of objects 304 present in the physical area and depicted in the video data 308. In some embodiments, analytics device 306 may also perform object re-identification on video data 308, allowing it to recognize an object 304 in video data 308 as being the same object that was previously detected.

As noted above, there is an ever-increasing push to equip surveillance and other video capture systems (e.g., video conferencing systems, etc.) with cameras that provide the ‘best’ performance in terms of video resolution, High Dynamic Range (HDR) support and features, etc. However, a key observation herein is that many machine learning (ML) algorithms used for video analytics today are, at best, agnostic to these performance enhancements. For example, many ML algorithms support input video data of up to Video Graphics Array (VGA) quality, which corresponds to a maximum resolution of 640×480 pixels. This means that additional processing is required to first convert higher resolution images into lower resolution images for analysis.

Another consideration with respect to ML-based video analytics is that lower resolution cameras typically provide higher frame rates than that of higher resolution cameras. Thus, the use of a higher resolution camera for purposes of providing input video to an ML model may not only require pre-processing of the images to lower their resolution, but also present a bottleneck to the inference rate of the model. Indeed, the higher the frame rate, the greater the number of images input to the model in a given timeframe, leading to quicker inferences about the video (e.g., object detection and/or classification, person or object behavioral analytics, etc.).

—ML-Based Video Analytics Using Cameras with Different Frame Rates—

The techniques introduced herein provide for a dual pipeline approach with respect to video processing and analytics. In some aspects, a first camera offering a higher frame rate provides its captured video for analysis by a machine learning (ML) model. Such a model may perform

Illustratively, the techniques described herein may be performed by hardware, software, and/or firmware, such as in accordance with the video analytics process 248, which may include computer executable instructions executed by the processor 220 (or independent processor of interfaces 210), to perform functions relating to the techniques described herein.

Specifically, according to various embodiments, a device makes an inference about video data from a first camera using a machine learning model. The device processes video data from a second camera that has a lower frame rate than that of the video data from the first camera. The device performs a mapping of the inference about the video data from the first camera to the video data from the second camera processed by the device. The device provides an indication of the mapping for display.

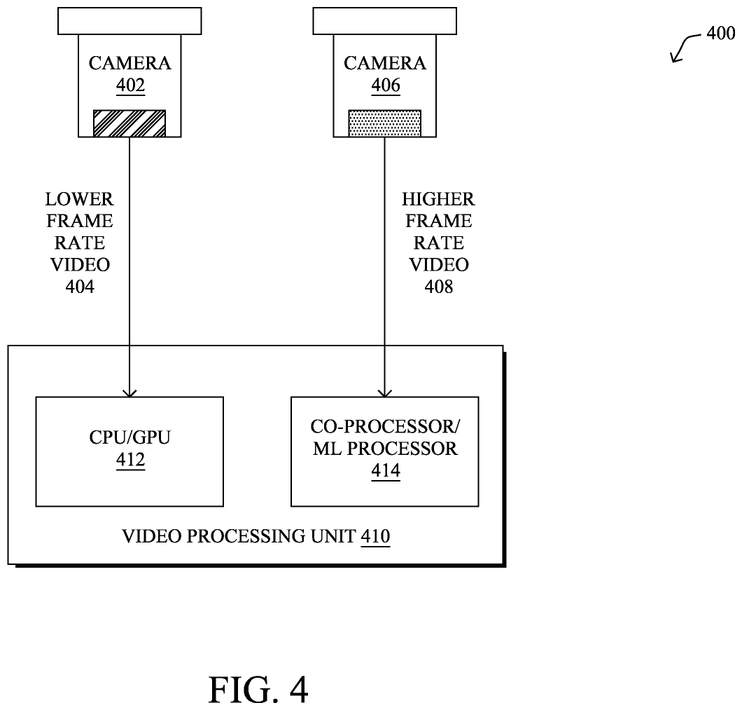

Operationally, in various embodiments, FIG. 4 illustrates an example architecture 400 for machine learning-based video analytics using cameras with different frame rates, according to various embodiments. At the core of architecture 400 are at least two cameras: a first camera 402 that captures and provides video data 404 at a lower frame rate than that of a second camera 406 that captures and provides video data 408 at a higher frame rate than that of camera 402.

Typically, the resolution of camera 402 will be greater than that of camera 406, thereby accounting for its lower relative frame rate. For instance, camera 406 may take the form of a 1.2 Megapixel (MP) or VGA camera, while camera 402 may take the form of a 1080p, 4 MP, 5 MP, etc. camera. As would be appreciated, other resolutions could also be used for camera 402 and camera 406, so long as the frame rate of camera 406 is relatively greater than that of camera 402. Preferably, the resolution of at least camera 406 is within the input range of the machine learning model(s) to be used to perform the video analytics.

As shown, video data 404 from camera 402 and video data 408 from camera 406 may be provided as input to a video processing unit 410, which comprises a video processing central processing unit (CPU) or graphics processing unit (GPU) 412, as well as a co-processor 414. In various embodiments, video processing unit 410 may be resident within the same housing as that of camera 402 and/or camera 406. For instance, CPU/GPU 412 may be part of the same system on a chip (SoC) as that of co-processor 414. In other embodiments, some or all of video processing unit 410 may be in communication with one another and/or camera(s) 402, 406, such as via a network.

According to various embodiments, video processing unit 410 may implement two distinct pipelines:
1.) A first pipeline in which CPU/GPU 412 performs video processing on the lower frame rate video data 404 from camera 402. For instance, CPU/GPU 412 may perform image quality improvements such as, but not limited to, rescaling, noise reduction, de-skewing, thresholding, morphological operations, or other such functions on video data 404.
2.) A second pipeline in which co-processor 414 uses one or more machine learning models to perform analytics on the higher frame rate video data 408 from camera 406. For instance, such a model may comprise a neural network, convolutional neural network, or other form of machine learning model that has been configured to perform video analytics tasks such as, but not limited to, any or all of the following: object or person detection, object or person re-identification, object or person classification (e.g., determining the type of the object, characteristics of the person, etc.), behavioral analytics, event detection, or the like.

As would be appreciated, video data 408 will be stable and received by video processing unit 410 (and, more specifically, co-processor 414) at a known frame rate. In addition, video data 408 will not be modified by any image signal processor (ISP), thereby giving better initial conditions for convolutional neural networks or similar machine learning (ML) models. In contrast, video data 404 will be received by video processing unit 410 (and, more specifically, CPU/GPU 412) at a lower relative frame rate than that of video data 408 and some of its pixels will be modified, resulting in any ML model that analyzes it to have lower accuracy.

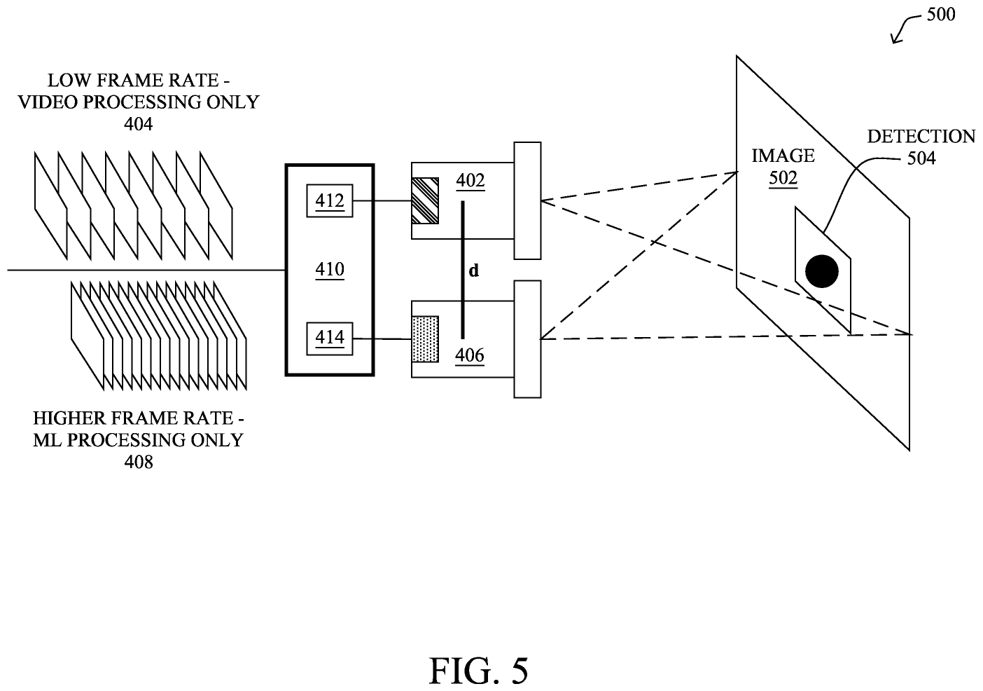

FIG. 5 illustrates an example 500 of the use of the architecture of FIG. 4 for video analytics, in various embodiments. As shown, the two pipelines of architecture 400 may result in two separate outputs:
1.) An image 502 that has been processed by CPU/GPU 412 and captured by camera 402 as part of the low frame rate video data 404.
2.) An inference made by the ML model(s) of co-processor 414, such as a detection 504 of a certain object, from the high frame rate video data 408 captured by camera 406.

In various embodiments, video processing unit 410 may perform a mapping between the outputs of the ML model(s) executed by co-processor 414 and the frames/images of video data 404, as processed by CPU/GPU 412. To do so, the outputs of the ML model(s) may include coordinates associated with any inferences made regarding video data 408. For instance, in the case of detection 504, the ML model may output the coordinates of the centroid of the detected object within video data 408, a set of coordinates that form a boundary for the object within video data 408, or the like.

A similar coordinate mechanism could also be used by video processing unit 410 with respect to other forms of inferences, as well, by the ML model(s). For instance, say a person has collapsed, indicating a medical emergency. A suitably trained ML model could detect this event and output the event label (e.g., “Medical Emergency Event—Collapsed Person”) and its associated coordinates indicating the location of the collapsed person in video data 408.

Since the distance (d) between camera 402 and camera 406 is known beforehand, video processing unit 410 can use this distance to compute and apply an offset to the coordinates associated with the inferences by the ML model(s) executed by co-processor 414, thereby mapping the inferences to the images processed by CPU/GPU 412. In other words, the mapping by video processing unit 410 may apply the inferences made by the ML model(s) executed by co-processor 414 to the frames/images processed by CPU/GPU 412.

In turn, video processing unit 410 may provide an indication of the mapping for display to a user. For instance, consider again the case of the ML model(s) executed by co-processor 414 detecting a medical emergency event. In such a case, video processing unit 410 may map the coordinates associated with the detected event to coordinates within one or more frames of video data 404 and generate an overlay for the corresponding frames/images processed by CPU/GPU 412 from video data 404, in one embodiment. In other embodiments, the indication of the mapping may take the form of other data provided in conjunction with the images/frames from CPU/GP 414. Regardless, the frames/images actually presented for display to a user may be of higher resolution than those of video data 408, thereby allowing the user to better see the detected event (e.g., a person that has fallen in the monitored area.

Optionally, in some embodiments, video data 404 may also be analyzed by one or more ML models by CPU/GPU 412 after it undergoes image processing and modification, leading to a second inference derived from video data 404 captured by camera 402. In such cases, video processing unit 410 may also perform a mapping between this second inference and the inference made by the ML model(s) executed by co-processor 414 with respect to video data 408. Doing so could, for instance, entail the formation of composite coordinates, classification labels, etc., which could then be provided for display to a user. For instance, assume co-processor 414 detects an emergency medical event, based on a person falling to the ground. A second inference made by an ML model executed by CPU/GPU 412 may then infer that the person that fell is elderly, which may only be possible from the higher resolution frames/images of video data 404.

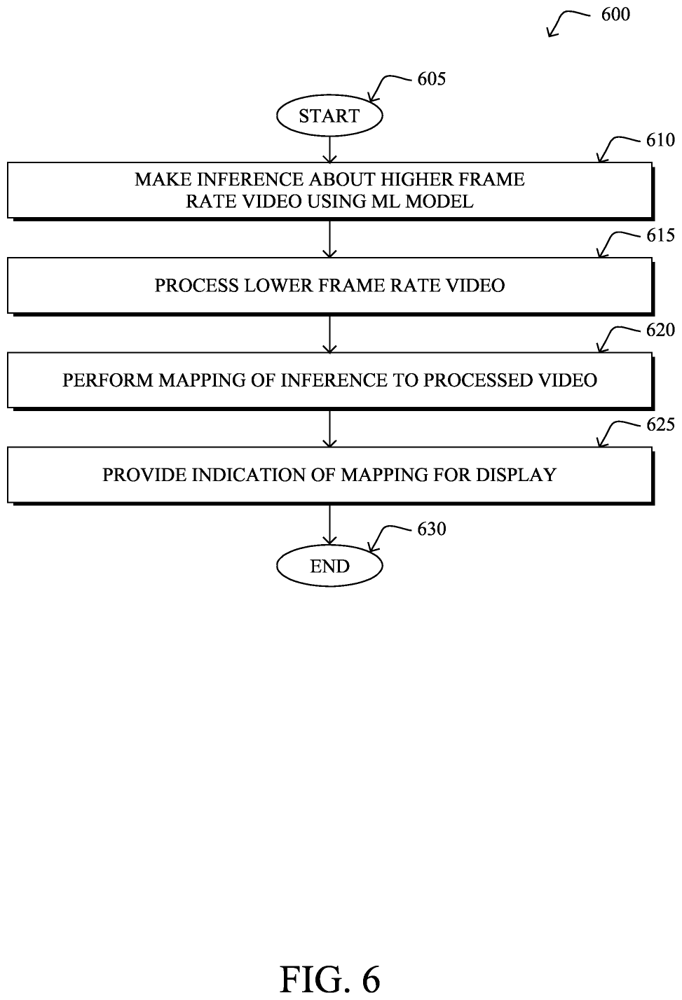

FIG. 6 illustrates an example simplified procedure 600 (e.g., a method) for machine learning-based video analytics using cameras with different frame rates, in accordance with one or more embodiments described herein. For example, a non-generic, specifically configured device (e.g., device 200) may perform procedure 600 by executing stored instructions (e.g., video analytics process 248). The procedure 600 may start at step 605, and continues to step 610, where, as described in greater detail above, the device may make an inference about video data from a first camera using a machine learning model. In some embodiments, the machine learning model detects an event or behavior depicted in the video data from the first camera. In another embodiment, the machine learning model is a neural network.

At step 615, as detailed above, the device may process video data from a second camera that has a lower frame rate than that of the video data from the first camera. In various embodiments, the device executes the machine learning model using a first processor and processes the video data from the second camera using a second processor. According to various embodiments, the video data from the first camera has lower resolution than that of the video data from the second camera. In some embodiments, the device may process the video data from the second camera by performing rescaling, noise reduction, de-skewing, thresholding, or a morphological operation on the video data from the second camera. In a further embodiment, the device comprises the first and second cameras.

At step 620, the device may perform a mapping of the inference about the video data from the first camera to the video data from the second camera processed by the device, as described in greater detail above. In some embodiments, the mapping is based in part on a physical distance between the first camera and the second camera. In one embodiment, the device may perform the mapping by mapping coordinates output by the machine learning model relative to the video data from the first camera to coordinates of the video data from the second camera.

At step 625, as detailed above, the device may provide an indication of the mapping for display. In some embodiments, the indication comprises an overlay for the video data from the second camera processed by the device.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for machine learning-based video analytics using cameras with different frame rates, it is to be understood that various other adaptations and modifications may be made within the spirit and scope of the embodiments herein. For example, while certain embodiments are described herein with respect to specific use cases for the techniques herein, the techniques can be extended without undue experimentation to other use cases, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
making, by a device, an inference about video data from a first camera using a machine learning model;
processing, by the device, video data from a second camera that has a lower frame rate than that of the video data from the first camera;
performing, by the device, a mapping of the inference about the video data from the first camera to the video data from the second camera processed by the device; and
providing, by the device, an indication of the mapping for display.

2. The method as in claim 1, wherein the device executes the machine learning model using a first processor and processes the video data from the second camera using a second processor.

3. The method as in claim 1, wherein the mapping is based in part on a physical distance between the first camera and the second camera.

4. The method as in claim 1, wherein the machine learning model detects an event or behavior depicted in the video data from the first camera.

5. The method as in claim 1, wherein the video data from the first camera has lower resolution than that of the video data from the second camera.

6. The method as in claim 1, wherein performing the mapping comprises:
mapping coordinates output by the machine learning model relative to the video data from the first camera to coordinates of the video data from the second camera.

7. The method as in claim 1, wherein processing the video data from the second camera comprises:
performing rescaling, noise reduction, de-skewing, thresholding, or a morphological operation on the video data from the second camera.

8. The method as in claim 1, wherein the device comprises the first camera and the second camera.

9. The method as in claim 1, wherein the indication comprises an overlay for the video data from the second camera processed by the device.

10. The method as in claim 1, wherein the machine learning model comprises a neural network.

11. An apparatus, comprising:
a network interface to communicate with a computer network;
one or more processors coupled to the network interface and configured to execute one or more processes; and
a memory configured to store a process that is executed by the one or more processors, the process when executed configured to:
make an inference about video data from a first camera using a machine learning model;
process video data from a second camera that has a lower frame rate than that of the video data from the first camera;
perform a mapping of the inference about the video data from the first camera to the video data from the second camera processed by the apparatus; and
provide an indication of the mapping for display.

12. The apparatus as in claim 11, wherein the apparatus executes the machine learning model using a first processor and processes the video data from the second camera using a second processor.

13. The apparatus as in claim 11, wherein the mapping is based in part on a physical distance between the first camera and the second camera.

14. The apparatus as in claim 11, wherein the machine learning model detects an event or behavior depicted in the video data from the first camera.

15. The apparatus as in claim 11, wherein the video data from the first camera has lower resolution than that of the video data from the second camera.

16. The apparatus as in claim 11, wherein the apparatus performs the mapping by:
mapping coordinates output by the machine learning model relative to the video data from the first camera to coordinates of the video data from the second camera.

17. The apparatus as in claim 11, wherein the apparatus processes the video data from the second camera by:
performing rescaling, noise reduction, de-skewing, thresholding, or a morphological operation on the video data from the second camera.

18. The apparatus as in claim 11, wherein the apparatus comprises the first camera and the second camera.

19. The apparatus as in claim 11, wherein the indication comprises an overlay for the video data from the second camera processed by the apparatus.

20. A tangible, non-transitory, computer-readable medium storing program instructions that cause a device to execute a process comprising:
making, by the device, an inference about video data from a first camera using a machine learning model;
processing, by the device, video data from a second camera that has a lower frame rate than that of the video data from the first camera;
performing, by the device, a mapping of the inference about the video data from the first camera to the video data from the second camera processed by the device; and
providing, by the device, an indication of the mapping for display.
